(19) United States
(12) Patent Application Publication
(10) Pub. No.: US 2003/0012627 A1
(43) Pub. Date: Jan. 16, 2003

(54) Apparatus for transferring front opener unified pod door in opener of front opener unified pod

(75) Inventors: Wan Keun Lee, Seoul (KR); Yong Pyo Kim, Songnam-city (KR)

Correspondence Address: Frank Chau, F. CHAU & ASSOCIATES, LLP, Suite 501, 1900 Hempstead Turnpike, East Meadow, NY, 11554, US

(73) Assignee: Shinsung Eng Corporation

(21) Appl. No.: 09/999,129

(22) Filed: Oct. 19, 2001

(30) Foreign Application Priority Data
Jul. 14, 2001 (KR) 2001-42558
Jul. 14, 2001 (KR) 2001-42559

(51) Int. Cl. B65G 49/07

(52) U.S. Cl. 414/217.1

(57) ABSTRACT

An apparatus for transferring a front opener unified pod (FOUP) door for a FOUP opener, in which a protection cover is provided to prevent an inflow of particles through a belt when a separated FOUP door moves up and down, or a lifter having an improved structure employing a ball screw mode and a door holder slider which is driven by a rack/pinion gear operated by a driving motor mounted thereon are provided. The FOUP door transfer apparatus for a FOUP opener includes: a door holder slider having a fixed plate provided with a rack gear at a predetermined position and a sliding plate on the upper portion of which a pinion gear door holder teeth-engaged with the rack gear of the fixed plate and moving along the rack gear; and a lifter including driving pulleys fixed on the upper and lower ends of a lift frame, a driving motor driving the driving pulleys, a driving belt connecting the driving pulleys and on one side of which a transfer piece is fixed, and the transfer piece on one end of which the driving belt is fixed and on the other end of which the support is connected, a lift frame accommodating the driving belt, and having an opening through which the transfer piece goes in and out, and a pair of left and right attachment pieces positioned in a lengthy direction along both ends of the opening, and a shield plate attached to the attachment pieces, shielding the opening of the lift frame from the outside.

### BACKGROUND OF THE INVENTION

1. Field of the Invention

The present invention relates to a FOUP (FRONT OPENER UNIFIED POD) door transfer apparatus for a FOUP opener, for transferring a door holder holding a separated FOUP door, in which the FOUP is a container accommodating a wafer having a large diameter and transferring the wafer to a working place, and more particularly, to a FOUP door transfer apparatus for a FOUP opener preventing dust generated from a belt in a lifter ascending and descending a FOUP door from flowing into purity equipment and securing a running stability.

2. Description of the Related Art

In general, wafers should be transported into a working place with a purity and stability in a semiconductor manufacturing process. The wafers are transferred to the entrance of a working chamber at the state that the wafers are contained in the FOUP shielded from the outside. The FOUP door in the transferred FOUP is opened through a FOUP opener and the wafers are withdrawn from the opened FOUP. In this process, the FOUP door is separated through a door holder and then closed if the wafers are completely withdrawn, and then returned to the original state. In this case, the door holder holding the FOUP door is retreated to the back of the FOUP opener and then descends and awaits until the withdrawal of the wafers are completed.

Hereinafter, a general structure of a FOUP opener will be described with reference to FIG. 1.

FIG. 1 is a perspective view schematically showing a general FOUP (Front Opener Unified Pod) and a FOUP opener.

In FIG. 1, a FOUP opener 100 is installed in an entrance side of processing equipment maintaining a local purity. That is, the FOUP opener 100 includes a vertical frame 110 shielding the entrance side of the processing equipment and a horizontal support 120 combined with the vertical frame 10. A stage 122 is installed on the support 120 of the FOUP opener 100, and a frame body 112 of the size of a FOUP 200 is provided in the vertical frame 110. A door holder 130 going forward and backward horizontally along the inner side is installed in the frame body 112. The door holder 130 includes predetermined devices opening a FOUP door 210 of the FOUP 200 mounted on the stage 122.

The opening of the FOUP 200 is primarily started by making the FOUP 200 closely contact the door holder 130. At the state where the FOUP door 210 of the FOUP 200 closely contacts the door holder 130 in the FOUP opener 100, the door holder 130 unlocks the lock of the FOUP door 210, and then makes the FOUP door retreated to open the FOUP 200. Then, wafers are withdrawn from the FOUP 200 to processing equipment in sequence. After the wafers are completely withdrawn, the FOUP door 210 closely contacting the door holder 130 is returned to the original state to then closely contact the FOUP 200 and then lock the FOUP door 210.

The lock and unlock of the FOUP door 210 are performed by inserting a latch key 140 provided in the door holder 130 of the opener 100 into a latch key hole 220 provided in the FOUP door 210. Also, two latch pins 150 are provided in the door holder 130, and then inserted into pin holes 230 of the FOUP door 210 in the FOUP 200, to thereby hold the opened FOUP door 210.

The door holder 130 held the FOUP door 210 separated from the FOUP container is retreated by a slider and then descends at the state that the FOUP door is held through a lifter. Thereafter, since the FOUP door is completely separated from the FOUP, wafers are carried into processing equipment.

A slider and a lifter for a FOUP door transfer apparatus in a FOUP opener will be described in detail with reference to FIGS. 2A through 2D.

FIGS. 2A and 2B are views schematically showing an existing slider for a FOUP door transfer apparatus in a FOUP opener, in which FIG. 2A is a sectional view thereof and FIG. 2B shows a schematic driving mechanism.

In an existing slider as shown in FIG. 2A, a fixed plate 14 is provided on the upper portion of a support 12 connected with the upper portion a lifter 10, and a transfer frame 20 fixed on the lower portion of a door holder 40 is horizontally movably mounted on the fixed plate 14.

Here, rail grooves 16a and 16b are formed on both sides of the fixed plate 14 in order to make the transfer frame 20 move smoothly. Guide members 22a and 22b are provided in the transfer frame 20 corresponding to the rail grooves 16a and 16b. Accordingly, the guide members 22a and 22b positioned in both sides of the transfer frame 20 are transferred and guided along the rail grooves 16a and 16b on the fixed plate 14. For such a driving, a transfer piece 24 fixed to the central inner side of the transfer frame 20 is fixed to a driving belt 34 wound on belt pulleys 32a and 32b driven by a driving motor 30. That is, as shown in FIG. 2B, the driving motor 30 is connected to either one side of a pair of belt pulleys 32a and 32b, and the driving belt 34 is wound around the belt pulleys 32a and 32b. The transfer piece 24 is fixed to the driving belt 34, and the transfer piece 24 is made to go forward and backward, to thereby make the door holder 40 linearly reciprocate. A reference numeral 36 denotes a tension adjustment roller for adjusting a belt tension.

As described above, since driving of an existing slider adopts a belt driving method, driving power is transmitted via various power transmission members. Accordingly, it is difficult to control the existing slider. Also, the existing slider has a complicated structure. In particular, a backlash is generated in the driving piece and the driving belt is easily loosed, which causes a severe error for a transfer control. Accordingly, the existing lifting apparatus is not stable in its operation, and the complicated structure and numerous components lower productivity and increase a manufacturing cost. In addition, since an electrical wire is connected between the fixed plate and the transfer frame in the driving motor, the electrical wire is interfered with or twisted with the transfer frame.

FIG. 2C is a transversely sectional view schematically showing an existing lifter for a FOUP door transfer apparatus in a FOUP opener, and FIG. 2D is an operational diagram for explaining problems in driving of a conventional lifter.

Driving of an existing lifter adopts a belt driving method. As shown in FIGS. 2C and 2D, any one of a pair of upper and lower belt pulleys 50 is driven by a driving motor 70, and a driving belt 52 is wound around the belt pulleys 50 and is made to rotate. A support 12 on which a door holder 40 is mounted is fixed on the upper side of the driving belt 52, to thereby make the support 12 descend and ascend according to movement of the belt.

As described above, since the existing lifter driving adopts a belt driving method, driving power is transmitted via various power transmission members. Accordingly, it is difficult to control the existing lifter. Also, the existing lifter has a complicated structure. In particular, a backlash is generated in the fixed portion of the support 12 fixed to the driving belt 52 and the driving belt is easily loosed, which makes it difficult to control an accurate driving. In particular, a belt is driven and worn to thereby generate dust due to the wear of the belt and flow into processing equipment via an entrance/exit hole 62 in the lift frame 60, to thereby cause a severe problem that a place which should maintain a high purity is polluted.

### SUMMARY OF THE INVENTION

To solve the above problems, it is an object of the present invention to provide a FOUP door transfer apparatus for a FOUP opener having a door holder slider on the fixed portion of which a driving motor is mounted and driven by using a rack/pinion gear, which gives a simplified structure and secures a running stability.

It is another object of the present invention to provide a FOUP door transfer apparatus for a FOUP opener having a lifter for preventing dust generated in a belt from flowing into purity equipment in which a protection cover is mounted in a belt system.

It is another object of the present invention to provide a FOUP door transfer apparatus for a FOUP opener having a lifter for solving dust generated due to a belt driving fundamentally, in which a ball screw driving method is adopted instead of a belt driving method.

To accomplish the above object of the present invention, there is provided a lifter for a FOUP door transfer apparatus in a FOUP opener, in which a driving belt is wound around driving pulleys fixed to the upper and lower ends thereof, and the driving pulleys are driven by a driving motor, to thus ascend and descend a support to which a door holder in the FOUP opener is fixed, the lifter comprising: a transfer piece on one end of which the driving belt is fixed and on the other end of which the support is connected; a lift frame accommodating the driving pulleys and the driving belt wound around the driving pulleys to transfer the transfer piece up and down, and having an opening through which the transfer piece goes in and out, and a pair of left and right attachment pieces positioned in a lengthy direction along both ends of the opening; and a shield plate attached to the attachment pieces, for shielding the opening of the lift frame from the outside.

There is also provided a lifter for a FOUP door transfer apparatus in a FOUP opener, which is fixed to a main frame in the FOUP opener, for ascending and descending a support to which a door holder is fixed, the lifter comprising: a pair of upper and lower support plates spaced from each other by a predetermined distance and fixed to the main frame; a pair of left and right guide rods spaced from each other by a predetermined distance vertically between the upper and lower support plates, and both ends of which are fixed; a transfer screw rod disposed in parallel with the guide rods and both ends of which are rotatably fixed to the upper and lower support plates; a transfer piece having a ball nut portion combined with the transfer screw rod, which descends and ascends according to rotation of the transfer screw rod, has guide holes through which the guide rods are penetrated on both sides thereof, and makes the support combined on the lateral side thereof; and a driving unit combined on one end of the transfer screw rod and rotationally driving the transfer screw rod.

### BRIEF DESCRIPTION OF THE DRAWINGS

The above objects and other advantages of the present invention will become more apparent by describing the preferred embodiment thereof in more detail with reference to the accompanying drawings in which:

FIG. 1 is a perspective view schematically showing a general FOUP (Front Opener Unified Pod) opener;

FIGS. 2A and 2B are views schematically showing an existing lifter for a FOUP door transfer apparatus in a FOUP opener;

FIGS. 2C and 2D are views schematically showing an existing slider for a FOUP door transfer apparatus in a FOUP opener;

FIGS. 3A through 3D are views schematically showing a slider for a FOUP door transfer apparatus in a FOUP opener according to the present invention;

FIGS. 4A through 4D are views schematically showing a lifter for a FOUP door transfer apparatus in a FOUP opener according to the present invention;

FIG. 5 is a sectional view taken along line A-A of FIG. 4B;

FIG. 6 is a sectional view taken along line B-B of FIG. 4A;

FIGS. 7A through 7G are views schematically showing a lifter for a FOUP door transfer apparatus in a FOUP opener according to another embodiment of the present invention; and

FIGS. 8A through 8C are views for explaining operations of the lifter shown in FIGS. 7A through 7G.

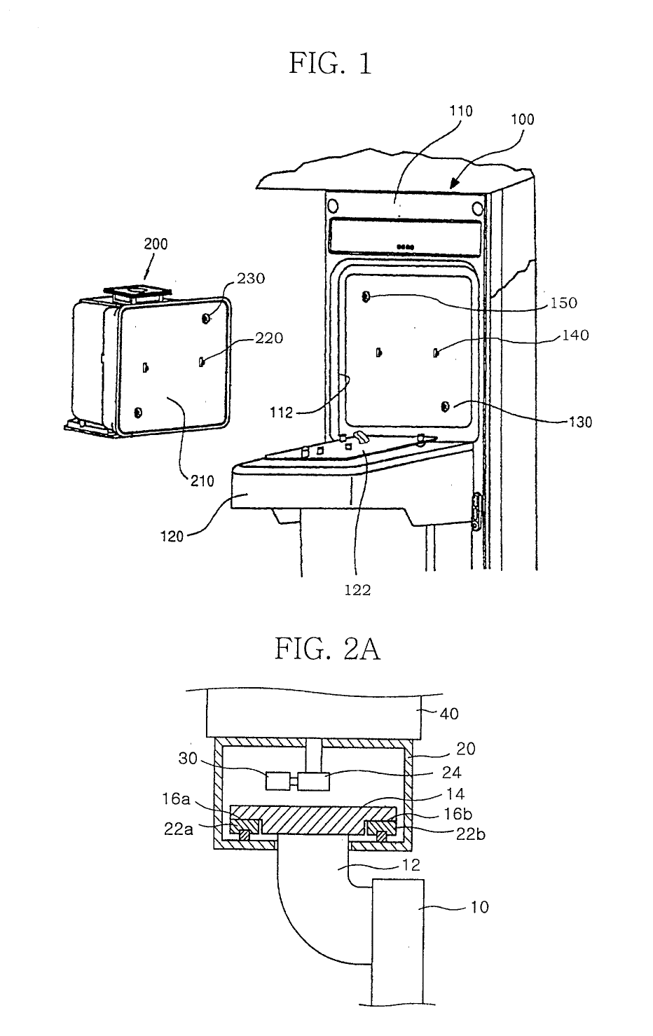

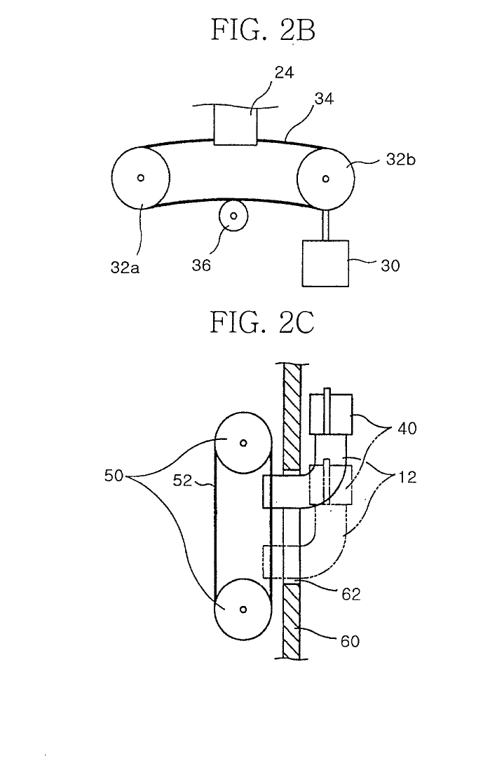

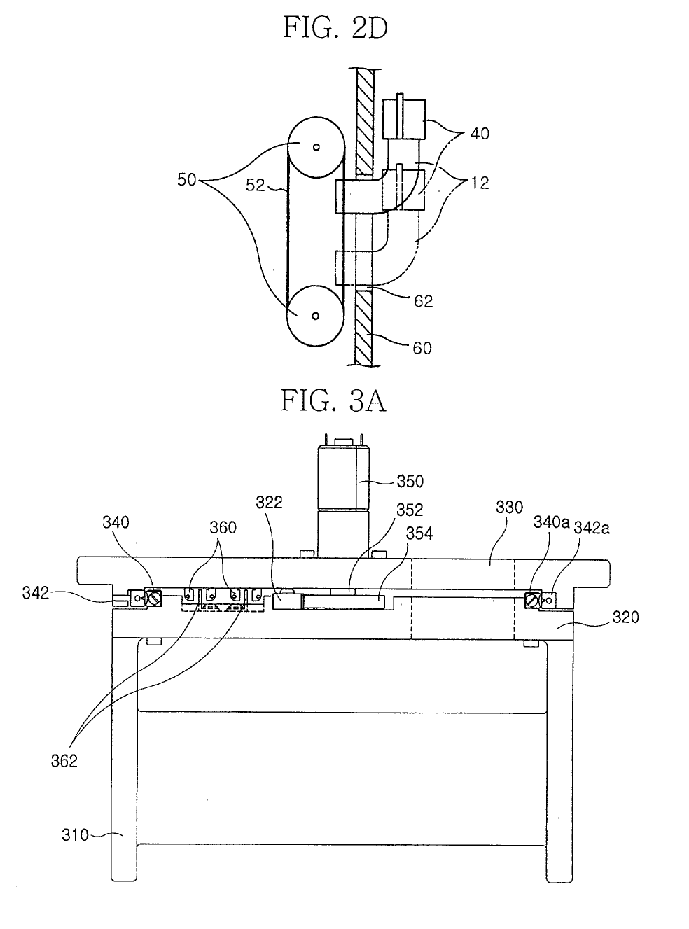

### DETAILED DESCRIPTION OF THE INVENTION

Preferred embodiments of the present invention will be described with reference to the accompanying drawings.

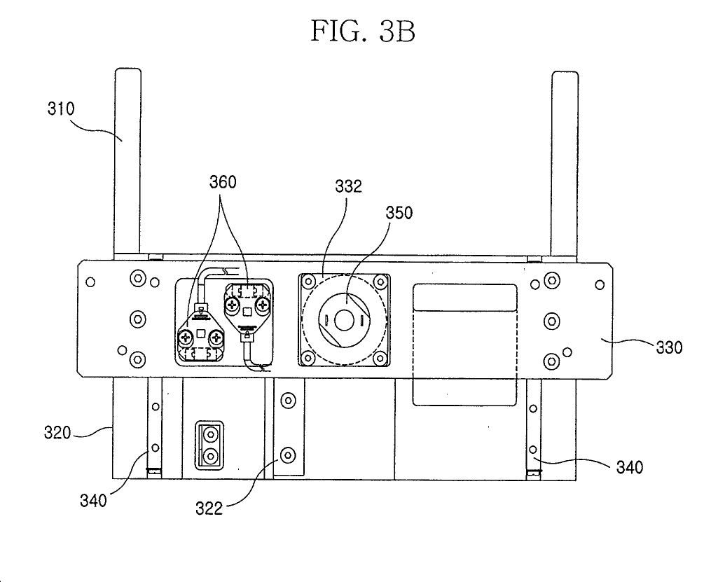

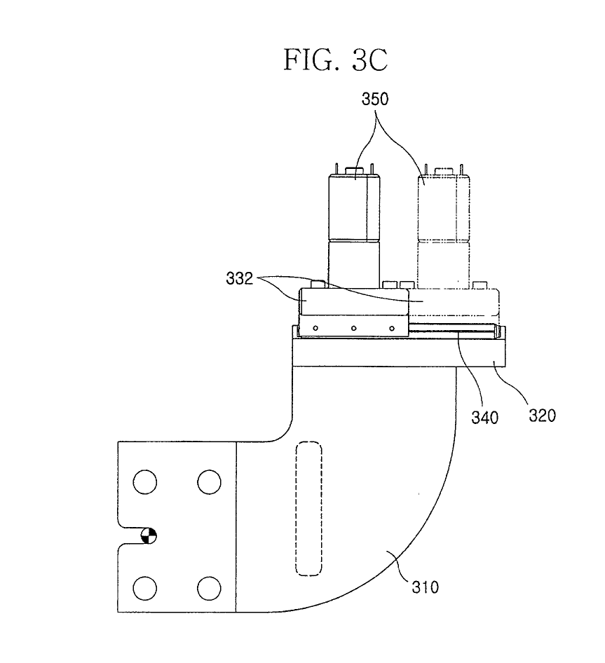

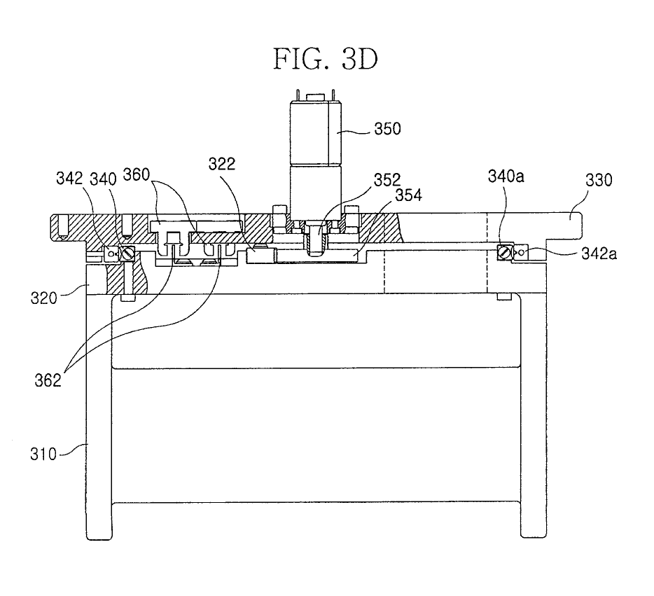

FIGS. 3A through 3D are a front view, a plan view, a side view and a partially sectional view schematically showing a door holder slider for a FOUP door transfer apparatus in a FOUP opener according to the present invention, respectively.

As shown, a fixed plate 320 is installed on the upper portion of a support arm 310. A sliding plate 330 is mounted on the fixed plate 320 and horizontally slidingly moves on the fixed plate 320. Accordingly, a door holder (not shown) fixed to the sliding plate 330 is made to go forward and backward. Here, a guide unit is installed between the sliding plate 330 and the fixed plate 320, in order to smoothly guide the sliding plate 330 on the fixed plate 320. That is, first guide rails 340 and 340a are fixed on the fixed plate 320 as a guiding unit, and second guide rails 342 and 342a are installed on the sliding plate 330 corresponding to the fixed plate 320, to thereby make the fixed plate 320 and the sliding plate 330 slidingly contact each other and perform a smooth sliding operation. Of course, bearings are interposed in the first and second guide rails 340, 340a, 342 and 342a.

Meanwhile, a driving motor 350 is fixed on the upper central portion of the sliding plate 330. The driving motor 350 is fixed by a motor bracket 332 so that the rotational shaft 352 of the driving motor 350 is protruded below the sliding plate 330. A pinion gear 354 is fixed on the rotational shaft 352. A rack gear 322 fixed in parallel with the first guide rails 340 and 340a on the fixed plate 320 is engaged with the pinion gear 354. Accordingly, when the pinion gear 354 is rotated, the pinion gear 354 moves along the rack gear 322, in which the pinion gear 354 makes the sliding plate 33 linearly move. Here, a position detection sensor 360 is attached on the lower portion of the sliding plate 330 in order to detect the movement of the sliding plate 330 and control the sliding plate 330. A sensor dog 362 is fixed on the upper portion of the fixed plate 320 corresponding to the sliding plate 320. Meanwhile, the driving motor 350 and the position detection sensor 360 requiring an electrical wire connection are fixed on the sliding plate 330. Thus, a wired cable is not twisted when the sliding plate 330 moves.

Hereinafter, the operation of the present invention will be described with reference to the accompanying drawings.

The FOUP door transfer apparatus operates if a door holder grasps a FOUP door and unlocks a locking device.

That is, when the driving motor 350 is driven, the pinion gear 354 is made to rotate. Accordingly, the pinion gear 354 moves along the rack gear 322 fixed on the fixed plate 320. When the pinion gear 354 slidingly moves along the rack gear 322, the sliding plate 330 on which the pinion gear 354 and the driving motor 350 are fixed, is also made to move. Here, the sliding plate 330 is smoothly transferred on the fixed plate 320 along the first guide rails 340 and 340a, if the second guide rails 342 and 342a fixed on both sides of the first guide rails 340 and 340a are guided. Of course, the position detection sensor 360 detects the position of the transferred sliding plate 330. When the sliding plate 330 reaches a predetermined position, the driving motor 350 stops to make the sliding plate 330 stop at the predetermined position.

Then, the retreated FOUP door ascends or descends according to the up and down movement of the lifter.

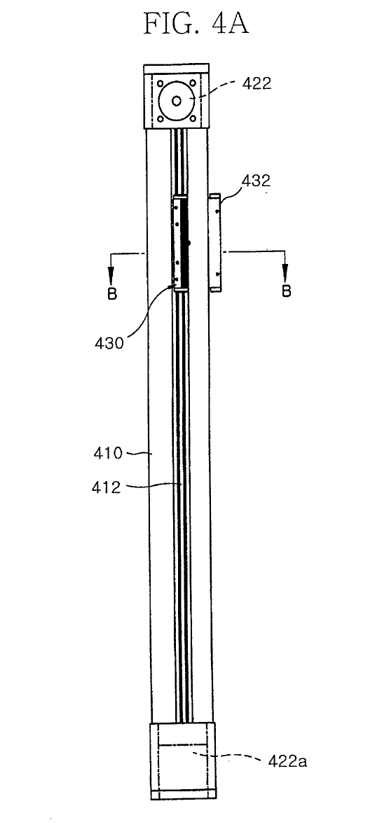

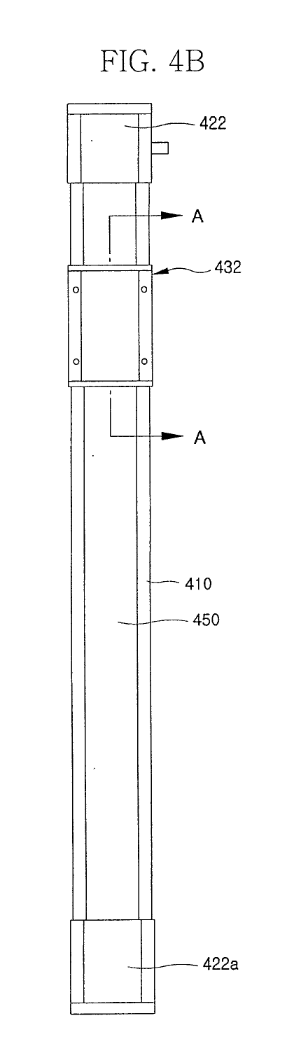

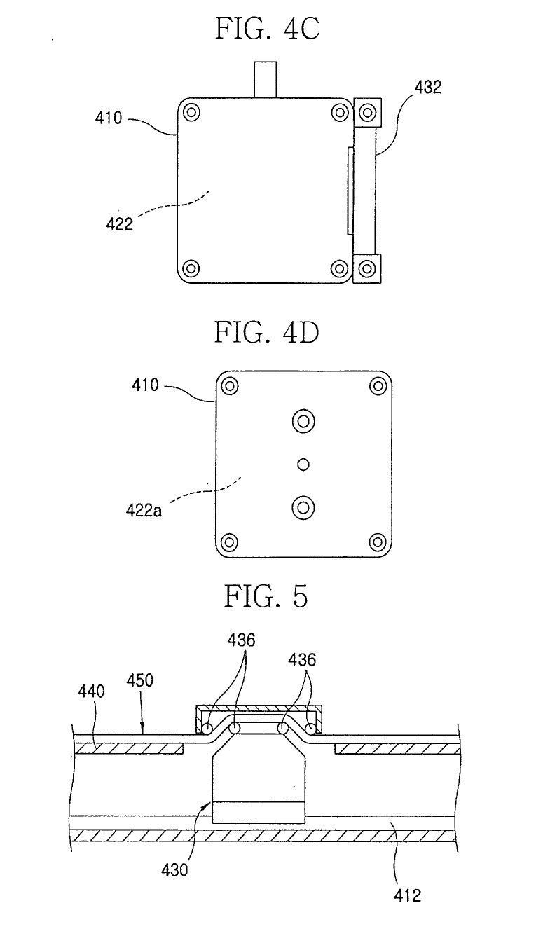

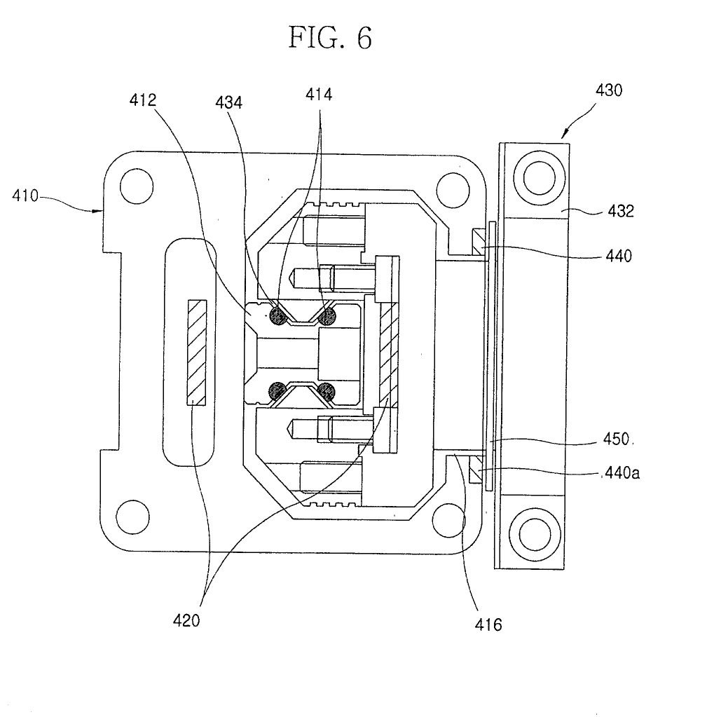

FIGS. 4A through 4D are views schematically showing a lifter for a FOUP door transfer apparatus in a FOUP opener according to the present invention, in which FIG. 4A is a front view thereof, FIG. 4B is a side view thereof, FIG. 4C is a plan view thereof and FIG. 4D is a bottom view thereof. FIG. 5 is a sectional view taken along line A-A of FIG. 4B. FIG. 6 is a sectional view taken along line B-B of FIG. 4A.

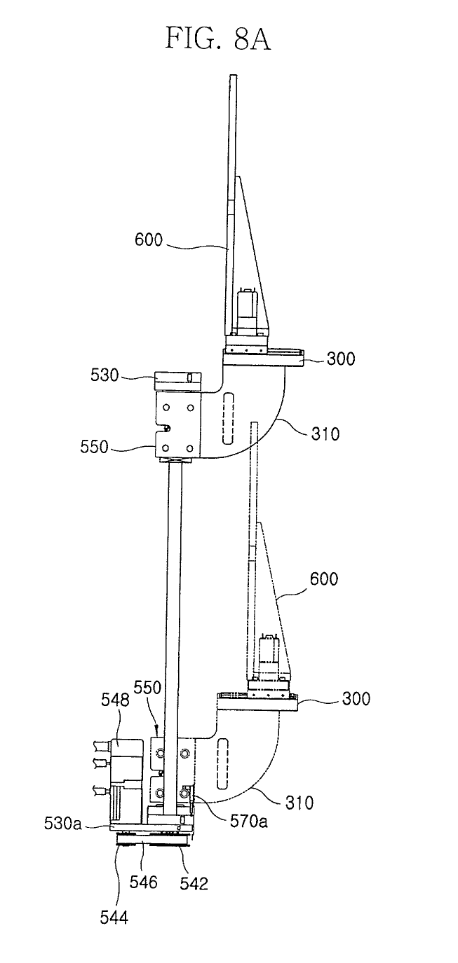

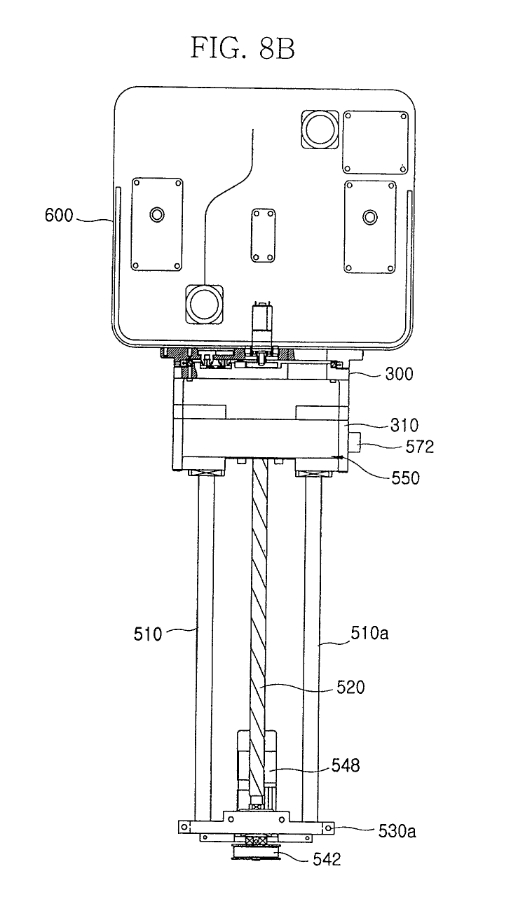

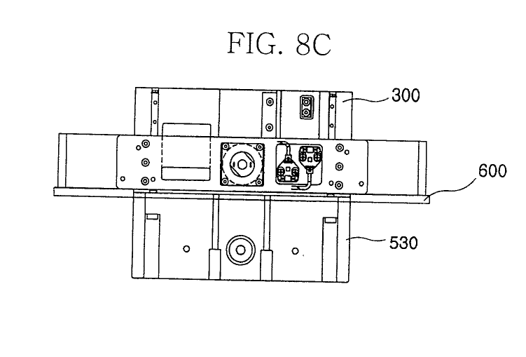

As shown in FIG. 6, a driving belt 420 and driving components are accommodated in a lift frame 410 which is vertically installed. As shown in FIGS. 4A through 4D, driving pulleys 422 and 422a are fixed on the upper and lower portions of the lift frame 410, in which a driving motor (not shown) is connected to one of the driving pulleys 422 to drive the driving pulleys 422. Accordingly, the driving belt 420 wound around the upper and lower driving pulleys 422 and 422a is transferred. A transfer piece 430 is fixed on a predetermined portion of the driving belt 420. The transfer piece 430 is protruded toward one side of the lift frame 410, to thereby form a support fixing plate 432. A support (not shown) is fixed on the support fixing plate 432, and the above-described door holder slider of FIGS. 3A through 3D is combined with the end of the support. FIG. 8A shows a relationship between the lifter and the slider.

An H-shaped guide groove 434 is formed in the transfer piece 430. A guide rail 412 fixed to the lift frame 410 is combined in the guide groove 434. Balls 414 which are buffering members are positioned between the guide rail 412 and the guide groove 434, to thereby induce a smooth operation during ascending and descending and decrease wear and noise.

Meanwhile, attachment pieces 440 and 440a are fixed along both ends of the left and right sides in the lengthy direction in the opening 416 of the lift frame 410 from which the transfer piece 430 goes in and out. A shield plate 450 is attached to the attachment pieces 440 and 440a from the outside, to thereby shield the opening 416 in the lift frame 410 from the outside. Accordingly, the driving belt 420 which rotates inside is isolated and shielded from the outside. Permanent magnets are used as the attachment pieces 440 and 440a and a thin film steel plate is used as the shield plate 450. In particular, the transfer piece 430 is transferred according to the movement of the driving belt 420, in which when the transfer piece 430 moves, both ends of the shield plate 450 are spaced from the attachment pieces 440 and 440a by a predetermined distance. For this purpose, a pair of upper and lower guide rollers 436 are provided in the support fixing plate 432 of the transfer piece 430 protruding from the opening 416 of the lift frame 410. Thus, when the transfer piece 430 moves upwards, the upper guide roller 436 guides the shield plate 450 and spaces the shield plate 450 from both sides of the attachment pieces 440 and 440a. Both ends of the passed shield plate 450 are attached and fixed to the attachment pieces 440 and 440a by the lower guide roller 436.

As described above, although the transfer piece 430 ascends and descends, the lifter does not form any gap between the shield plate 450 and the attachment pieces 440 and 440a of the opening 416 in the lift frame 410, since the shield plate 450 and the attachment pieces 440 and 440a are separated from and attached to each other immediately, to thereby avoid dust due to the driving of the belt 420 from being exposed to the outside.

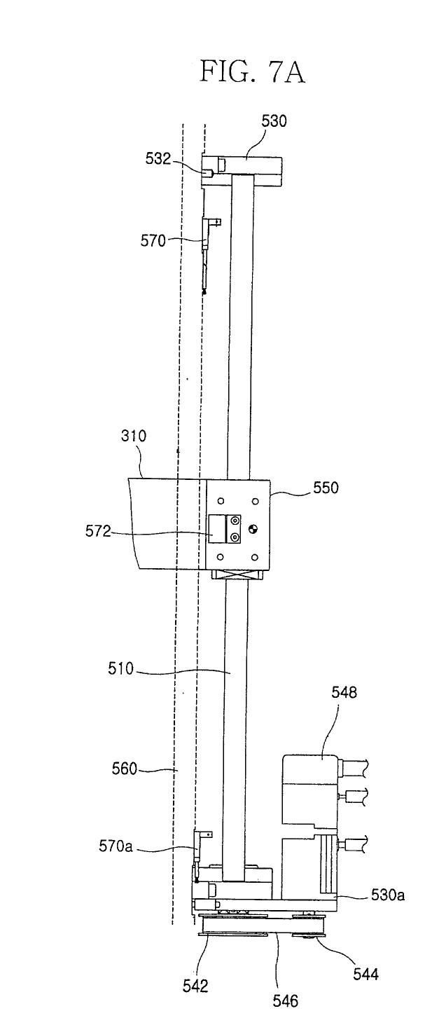

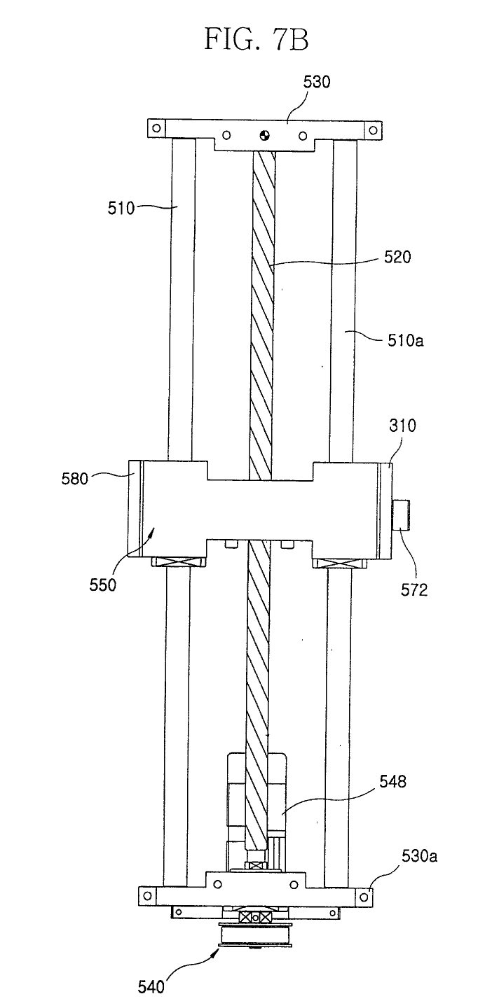

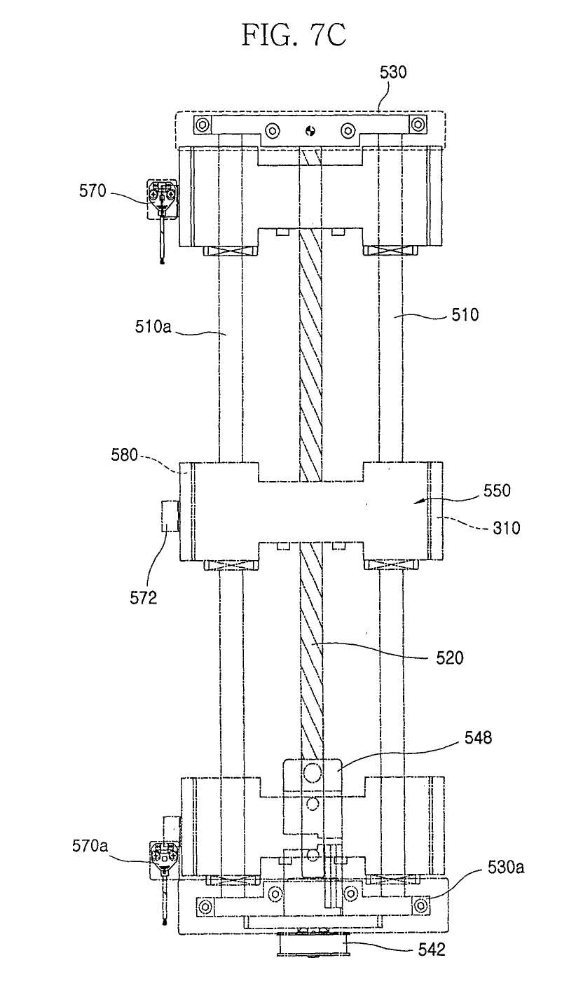

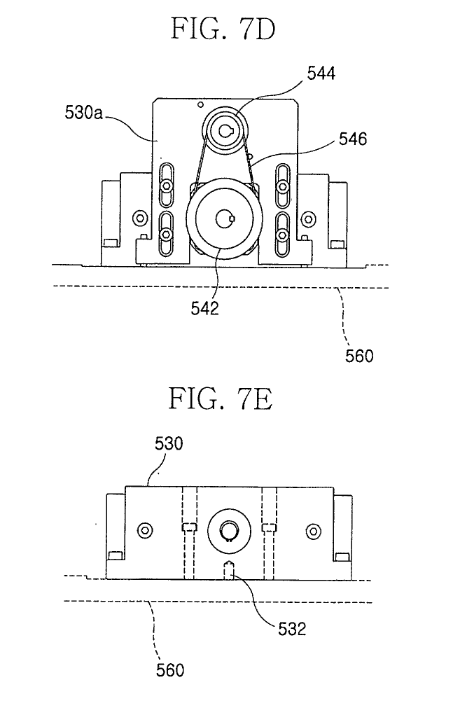

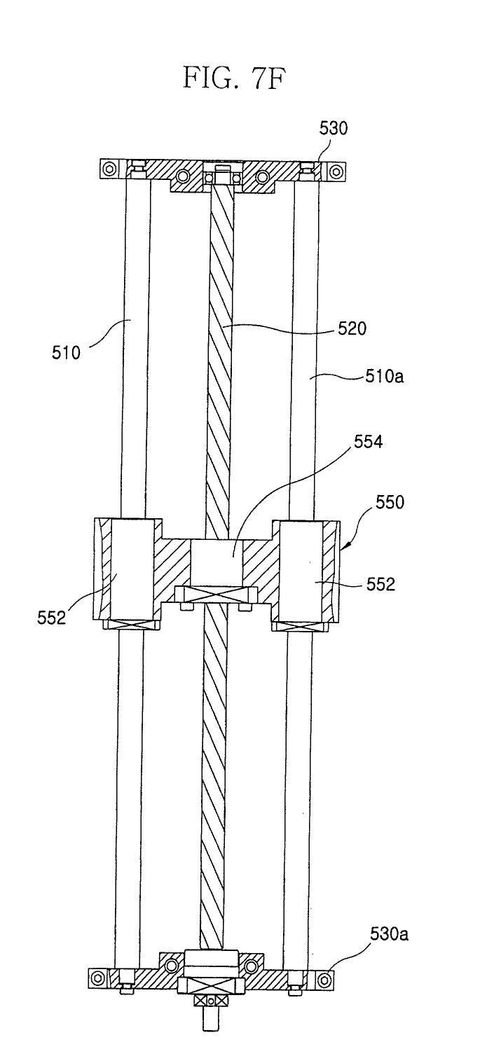

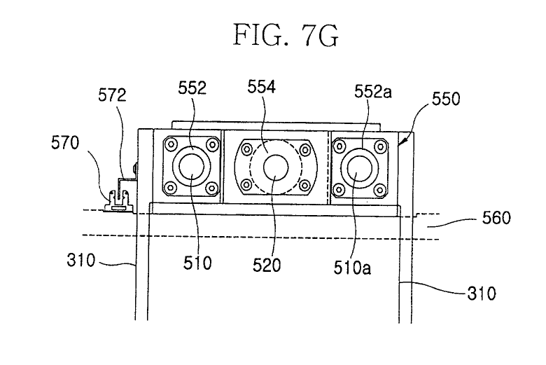

FIGS. 7A through 7G are views schematically showing a lifter for a FOUP door transfer apparatus in a FOUP opener according to another embodiment of the present invention. FIG. 7A is a front view of the lifter, FIG. 7B is a lefthand side view thereof, FIG. 7C is a righthand side view thereof, FIG. 7D is a bottom view thereof, FIG. 7E is a plan view thereof, FIG. 7F illustrates a relationship of combination of the transfer plate, the guide rod and the transfer screw rod in FIG. 7A, and FIG. 7G shows a transfer plate taken from FIG. 7F in detail.

In the lifter according to the present invention, a pair of left and right guide rods 510 and 510a which are vertically installed and a transfer screw rod 520 disposed in parallel between the guide rods 510 and 510a are fixed to the upper and lower support plates 530 and 530a. A driving unit 540 is connected to one end of the transfer screw rod 520. The driving unit 540 will be described below in more detail.

A driven pulley 542 is fixed to one end of the transfer screw rod 520, that is, the lowermost end after penetrating the lower support plate 530a in the drawing. The driven pulley 542 is connected to a driving pulley 544 positioned spaced from the driven pulley 542 by a predetermined distance with a driving belt 546. The driving pulley 544 is connected to a driving motor 548 upside down on the lower support plate 530a. Thus, the driving pulley 544 is rotated according to rotation of the driving motor 548. The rotational driving force is transmitted to the driven pulley 542, to thereby make the driven pulley 542 rotate the fixed transfer screw rod 520.

The transfer screw rod 520 and the left and right guide rods 510 and 510a penetrate a transfer piece 550. That is, the transfer piece 550 is provided with perforated guide holes 552 and 552a through which the left and right guide rods 510 and 510a penetrate and a ball nut portion 554 teeth-engaged with the transfer screw rod 520 in the middle position. Accordingly, the ball nut portion 554 is linearly transferred according to rotation of the transfer screw rod 520, to thereby make the transfer piece 550 move up and down.

Further, the above-described upper and lower support plates 530 and 530a are fixed to the main frame 560. As shown in FIG. 7G, position detection sensors 570 and 570a are mounted in the upper and lower portions of the main frame 560, to thereby detect position of the transfer piece 550 according to position of a sensor dog 572 attached to the transfer piece 550 and control the transfer piece 550. Meanwhile, a position adjustment pin 532 for adjusting the position of the upper support plate 530 and grounding the upper support plate 530 is fixed between the main frame 560 and the upper support plate 530. A reference numeral 310 denotes a support ram on the upper portion of which a slider is fixed.

FIGS. 8A through 8C are views for explaining operations of the lifter shown in FIGS. 7A through 7G. FIG. 8A is a front view thereof, FIG. 8B is a side view thereof and FIG. 8C is a plan view thereof. Referring to FIGS. 8A through 8C, the lifter according to the present invention shown in FIGS. 7A through 7G will be described below.

As shown with a solid line, if a door holder 600 holds a FOUP door (not shown) and a slider 300 is retreated, a driving motor 548 in the lifter according to the present invention is driven. Then, the driving pulley 544 fixed to the shaft of the driving motor 548 is rotates. The rotation of the driving pulley 544 is transmitted to the driven pulley 542 through the driving belt 546 and makes the transfer screw rod 520 rotate. Accordingly, the transfer screw rod 520 rotates to thereby make the transfer piece 550 on which the ball nut portion 554 teeth-engaged with the transfer screw rod 520 is formed fall down. In this case, the transfer piece 550 is guided by the guide rods 510 and 510a combined with the guide holes 552 and 552a positioned on both sides and descends stably. Then, if the transfer piece 550 reaches a position indicated as a two-dot solid line, the transfer piece 550 stops. Here, the descendent stop position is controlled by the position detection sensor 570a installed in the lower portion of the main frame 560 and detecting the position of the transfer piece 550. By doing so, the support 310 fixed to the transfer piece 550 also descends together with the transfer piece 550, and thus the slider 300 fixed on the upper portion of the support 310 and the door holder 600 fixed to the upper portion of the slider 300 hold the FOUP door and fall down.

As described above, in a FOUP door transfer apparatus for a FOUP opener according to the present invention, a driving motor is mounted on the fixed portion of a door holder slider and driven by using a rack/pinion gear. Accordingly, the present invention provides a simplified structure, heightens an assembly workability and saves a manufacturing cost. Also, a gear driving method is adopted instead of a belt driving method which is difficult to control a belt due to a belt tension, to thereby secure a running stability. In particular, since a position detection sensor and a driving motor are mounted on a slider in the present invention and electrically wired in the upper portion of the slider, the electrical wires are not twisted or interfered with other components during movement of the slider.

A FOUP door transfer apparatus for a FOUP opener according to the present invention, prevents dust generated in a belt from flowing into purity equipment in which a protection cover is mounted in a belt system.

A FOUP door transfer apparatus for a FOUP opener according to the present invention controls pollution materials flowing into purity equipment more perfectly, to thereby maintain a higher purity and reduce inferiority of semiconductor devices, in which a ball screw driving method is adopted instead of a belt driving method.

What is claimed is:

1. A FOUP (Front Opener Unified Pod) door transfer apparatus in a FOUP opener, the FOUP door transfer apparatus comprising:
a fixed plate fixed on the upper portion of a lifter, and on a predetermined position of the upper surface of which a rack gear is provided;
a pinion gear teeth-engaged with the rack gear of the fixed plate and moving along the rack gear;
a driving motor rotationally driving the pinion gear; and
a sliding plate on the upper portion of which a door holder is connected.

2. The FOUP door transfer apparatus of claim 1, further comprising a guide unit for smoothly guiding the sliding plate on the fixed plate.

3. The FOUP door transfer apparatus of claim 2, wherein said guide unit comprises first guide rails fixed in parallel with the rack gear and fixed to both sides of the fixed plate, and second guide rails fixed to the sliding plate so as to move along the first guide rails.

4. The FOUP door transfer apparatus of claim 1, further comprising a position detection sensor for detecting position of the sliding plate on the sliding plate.

5. The FOUP door transfer apparatus of claim 1, wherein the driving motor is electrically wired on the upper portion of the sliding plate.

6. The FOUP door transfer apparatus of claim 4, wherein the position detection sensor is electrically wired on the upper portion of the sliding plate.

7. The FOUP door transfer apparatus of claim 1, further comprising a lifter wherein said lifter comprises:
driving pulleys fixed on the upper and lower portions of a lift frame;
a driving motor for driving the driving pulleys;
a driving belt connecting the driving pulleys and on one side of which a transfer piece is fixed;
the transfer piece on one end of which the driving belt is fixed and on the other end of which the support is connected;
a lift frame accommodating the driving pulleys and the driving belt wound around the driving pulleys to transfer the transfer piece up and down, and having an opening through which the transfer piece goes in and out; and
a shield plate attached to the attachment pieces, for shielding the opening of the lift frame from the outside.

8. The FOUP door transfer apparatus of claim 7, wherein said transfer piece comprises an H-shaped guide groove positioned in the lift frame and a support fixing plate for fixing the support on an end protruding from the opening.

9. The FOUP door transfer apparatus of claim 8, wherein a guide rail is inserted into the guide groove in the vertical direction in the lift frame, for guiding the transfer piece to ascend and descend vertically.

10. The FOUP door transfer apparatus of claim 9, wherein balls for reducing friction are interposed between the guide rail and the guide groove.

11. The FOUP door transfer apparatus of claim 8, further comprising a pair of upper and lower guide rollers for guiding the shield plate and facilitating attachment and detachment in the support fixing plate of the transfer piece.

12. The FOUP door transfer apparatus of claim 7, wherein said attachment pieces are permanent magnets and said shield plate attached to the attachment pieces is a thin film steel plate.

13. The FOUP door transfer apparatus of claim 7, wherein said lifter comprises:
a pair of upper and lower support plates spaced from each other by a predetermined distance and fixed to the main frame;
a pair of left and right guide rods spaced from each other by a predetermined distance vertically between the upper and lower support plates, and both ends of which are fixed;
a transfer screw rod disposed in parallel with the guide rods and both ends of which are rotatably fixed to the upper and lower support plates;
a transfer piece having a ball nut portion combined with the transfer screw rod, which descends and ascends according to rotation of the transfer screw rod, has guide holes through which the guide rods are penetrated on both sides thereof, and makes the support combined on the lateral side thereof, and
a driving unit combined on one end of the transfer screw rod and rotationally driving the transfer screw rod.

14. The FOUP door transfer apparatus of claim 13, wherein said driving unit comprises:
a driving motor fixed on the lower support plate;
a driving pulley combined with the driving motor and rotating;
a driving belt wound around the driving pulley; and
a driven pulley combined with the lowermost end of the transfer screw rod, for transmitting the driving power by means of the driving belt and making the transfer screw rod rotate.

15. The FOUP door transfer apparatus of claim 13, wherein position detection sensors for detecting top and bottom stop positions of the transfer piece are provided in the top and bottom interval of the main frame through which the transfer piece moves.

16. A FOUP (Front Opener Unified Pod) door transfer apparatus in a FOUP opener, the FOUP door transfer apparatus comprising:
a door holder slider fixed on the upper portion of a support in a lifter, having a fixed plate provided with a rack gear at a predetermined position on the upper surface thereof, a pinion gear door holder teeth-engaged with the rack gear of the fixed plate and moving along the rack gear is connected, a driving motor for rotationally driving the pinion gear, and a sliding plate on the upper portion of which a door holder is connected; and
the lifter including driving pulleys fixed on the upper and lower ends of a lift frame, a driving motor driving the driving pulleys, a driving belt connecting the driving pulleys and on one side of which a transfer piece is fixed, and the transfer piece on one end of which the driving belt is fixed and on the other end of which the support is connected, the lift frame accommodating the driving belt, and having an opening through which the transfer piece goes in and out, and a pair of left and right attachment pieces positioned in a lengthy direction along both ends of the opening, and a shield plate attached to the attachment pieces, shielding the opening of the lift frame from the outside.

17. A FOUP (Front Opener Unified Pod) door transfer apparatus in a FOUP opener, the FOUP door transfer apparatus comprising:
a door holder slider fixed on the upper portion of a support in a lifter, having a fixed plate provided with a rack gear at a predetermined position on the upper surface thereof, a pinion gear door holder teeth-engaged with the rack gear of the fixed plate and moving along the rack gear, a driving motor for rotationally driving the pinion gear, and a sliding plate on the upper portion of which a door holder is connected; and
the lifter including: a pair of upper and lower support plates spaced from each other by a predetermined distance and fixed to the main frame; a pair of left and right guide rods spaced from each other by a predetermined distance vertically between the upper and lower support plates, and both ends of which are fixed; a transfer screw rod disposed in parallel with the guide rods and both ends of which are rotatably fixed to the upper and lower support plates; a transfer piece having a ball nut portion combined with the transfer screw rod, which descends and ascends according to rotation of the transfer screw rod, has guide holes through which the guide rods are penetrated on both sides thereof, and makes the support combined on the lateral side thereof; and a driving unit combined on one end of the transfer screw rod and rotationally driving the transfer screw rod.
